(19) United States
(12) Patent Application Publication
(10) Pub. No.: US 2006/0144504 A1
(43) Pub. Date: Jul. 6, 2006

(54) Composites of reinforcing fibers and thermoplastic resins

(76) Inventor: Christopher M. Edwards, Midland, MI (US)

Correspondence Address: GARY C. COHN, PLLC, 1147 NORTH FOURTH STREET, UNIT 6E, PHILADELPHIA, PA, 19123, US

(21) Appl. No.: 11/323,661

(22) Filed: Dec. 30, 2005

Related U.S. Application Data
(60) Provisional application No. 60/640,525, filed on Dec. 31, 2004.

(51) Int. Cl. B29C 70/52

(52) U.S. Cl. 156/180; 156/166

(57) ABSTRACT

Pultruded composites are formed using polar thermoplastic resins as the polymer component. By selecting polymer that do not include certain reactive structures, and by substantially excluding various types of additives from the polymer, higher processing temperatures can be used to form the pultruded part, and significant resin degradation is avoided. This permits good quality pultruded parts to be made, at commercially reasonable line speeds and with relatively high cross-sectional areas.

### CROSS-REFERENCE TO RELATED APPLICATION

This application claims benefit of U.S. Provisional Application 60/640,525, filed Dec. 31, 2004.

### BACKGROUND OF THE INVENTION

This invention relates to pultruded composites.

Pultrusion is a process by which continuous reinforcing fibers are formed into composites with a constant cross-sectional shape and size. Bundles of reinforcing fibers are drawn continuously through a resin bath where the fiber surfaces become wetted with the resin. The wetted fibers are then drawn through one or more dies which remove excess resin and shape the fiber/resin mass into the desired cross-sectional shape. The resulting pultruded products contain multiple reinforcing fibers, aligned more or less parallel to each other and bound together with a polymeric resin binder material.

The properties of the pultruded products are highly dependent on the fiber content and the ability to obtain good wet-out of the fibers with the resin. These two requirements tend to work against each other, as complete fiber wet-out becomes more difficult as resin content is decreased to provide a high fiber content. In order to obtain satisfactory fiber wet out at commercially acceptable operating rates, it has been necessary to use resin materials that have low viscosities at the process operating temperatures.

The requirement for low resin viscosities has largely limited commercial pultrusion processes to using thermosetting resins as the binder material. Low viscosity resin precursor materials are used to wet out the fibers, and are subsequently cured to create the composite. Good wet-out is obtained, but after the resin is cured, the resulting composite can no longer be formed or re-shaped. It is sometimes desirable to introduce bends or otherwise re-shape the pultruded part for use in specialized applications.

Thermoplastic binder materials offer the possibility of forming pultruded parts that can be post-formed by heating to the softening temperature of the binder. As such, there is an interest in using thermoplastic binders in a pultrusion process. The problem, however, is that thermoplastic resins of sufficient molecular weight to provide the necessary physical properties form high viscosity melts. It is difficult to obtain good fiber wet-out using high viscosity materials.

For this reason, pultrusion processes using thermoplastic resin binders have been limited to slow line speeds and/or the production of very small cross-section pultruded parts. For example, U.S. Pat. No. 4,559,262 to Cogswell et al. describes a pultrusion process that employs a thermoplastic resin binder. Cogswell describes line speeds as high as 5 meters/minute when producing very thin (0.1 mm) pultruded tapes. However, Cogwell's line speeds drop to 20-60 cm/minute when 3-mm diameter rods are produced. Moreover, the process described by Cogswell is limited to low molecular weight resins. Higher molecular weight resins can be used in Cogswell's process only when purposefully degraded during the pultrusion process to reduce molecular weight and melt viscosity. Similarly, U.S. Pat. No. 4,588,538 describes making 3-5 mil pultruded tapes using a thermoplastic binder, by using a special air jet spreading device to separate the individual fibers before the impregnation step. However, line speeds are reported at only 30 cm/minute.

The resin melt viscosity can be reduced by increasing the processing temperature. However, polymer degradation becomes a significant problem when higher temperatures are used. As a result, the potential benefit of increased line speed that can be obtained by using higher processing temperatures are offset by the poorer performance of the resulting composite, due to the degradation of the resin.

U.S. Pat. No. 5,891,560 to Edwards et al. describes another approach to making pultrusions using thermoplastic materials. In this instance, the thermoplastic material is one which undergoes a thermal depolymerization reaction, and is then capable of repolymerizing when cooled. Examples of such materials include certain thermoplastic polyurethanes that contain residual polymerization catalyst. This particular class of binder materials largely overcomes the viscosity problems which are seen with other thermoplastic binder materials. However, this approach is limited to specific classes of binder materials, which may be too expensive and/or lack physical properties that are required for certain applications. It would therefore be desirable to provide a process by which pultruded composites can be made using a variety of thermoplastic binder materials, and at good line speeds, while still producing pultruded parts having good properties and at a wider variety of cross-sections.

### SUMMARY OF THE INVENTION

In one aspect, this invention is a method for preparing a fiber-reinforced thermoplastic composite article comprising the steps of

a) drawing a fiber bundle continuously through a molten polar thermoplastic polymer, so as to impregnate said fiber bundle with said polar thermoplastic polymer;

b) forming the impregnated fiber bundle into a shaped article having longitudinally oriented fibers; and then

c) cooling the shaped article to a temperature at which the polar thermoplastic polymer solidifies,

wherein said polar thermoplastic polymer is substantially devoid of non-aromatic carbon-carbon unsaturation, reactive ring structures, and materials that act to degrade the polymer at the pultrusion processing temperature.

It has been found that certain types of functional groups, impurities and additives, when present in the thermoplastic resin, tend to promote degradation of the molten resin. The functional groups that tend to promote polymer degradation include non-aromatic carbon-carbon sites of unsaturation, certain types of ring structures, as described more fully below, and functional groups containing active hydrogen atoms (such as hydroxyl, primary or secondary amino groups, carboxylic acid and thiol groups). Other materials that may promote polymer degradation at higher processing temperatures include commonly used additives such as antioxidants; colorants such as pigments or dyes; impact modifiers; rubbers; biocides such as antimicrobials or fungicides; flame retardants; UV stabilizers; antistatic agents; demolding agents; and flow promoters. In addition, thermal degradation of the polymer can be promoted by the presence of impurities, such as residual catalysts (and degradation products thereof), transition metal ions, and the like. When these functional groups, impurities and additives are absent from the polymer, we have found that the polymer becomes more resistant to thermal degradation. The improved thermal stability of the polymer makes it possible to expose the polymer to higher temperatures during the pultrusion process. These higher temperatures can be significantly above the generally recommended useful range of processing temperatures for the polymer. The higher processing temperatures lower the melt viscosity of the polymer, facilitating good wet-out of the reinforcing fibers. The ability to improve wet-out allows higher line speeds to be used, even when thicker parts are produced, and when the parts have high fiber contents.

### DETAILED DESCRIPTION OF THE INVENTION

The impregnation process is preferably carried out using a combination of pultrusion of fiber and extrusion of a polymer resin melt in accordance with the process illustrated in U.S. Pat. No. 5,891,560. This preferred process includes the steps of pulling a fiber bundle through a preheat station, a fiber pretension unit, an impregnation unit, a consolidation unit that includes a die which shapes the composite to its finished shape, and a cooling die.

As shown in U.S. Pat. No. 5,891,560, a fiber bundle from a fiber storage rack is optionally pulled through a fiber preheat station, where the fibers are heated to remove any water and volatile materials present in or on the fibers, and to bring the fibers close to the temperature of the polymer melt. Infrared heaters are suitable for this purpose. Fiber preheating is not critical and can be omitted altogether, especially if the fibers are already dry and free of volatile materials. If preheated is performed, the fibers are typically heated to a temperature below that of the resin bath, such as from about 5 to about 150° C. below the temperature of the resin bath A preferred preheating temperature is 200° C. or below, especially about 175° C. or below.

Whether or not the fiber bundle is preheated, it is pulled through a fiber pretension unit where the individual fibers are spread out and placed under tension.

The fibers are then pulled through an impregnation unit where the fiber bundle is wetted with the molten thermoplastic polymer. The polymer melt is preferably dried to not more than 200 ppm water, more preferably not more than 100 ppm water prior to use. The dried resin is then advantageously extruded through a heated extruder, which melts the resin by way of shear and heat. The resin melt is then transported by way of a heated resin channel to the impregnation unit, where it contacts the fibers.

A suitable impregnation unit contains at least one impregnation pin and a series of rods. A suitable impregnation pin design is as described in U.S. Pat. No. 5,891,560, and includes a substantially cylindrical member containing a first longitudinal channel for resin melt transfer and a second longitudinal channel for a cartridge heater, which keeps the impregnation pin heated to a temperature above the melting point of the resin. The impregnation pin suitably contains in addition a slot formed by mounting an elongated member above a longitudinal opening in the impregnation pin coincident with the first channel. The longitudinal opening at the top of the impregnation pin provides a means for the resin melt to contact the fiber bundle, which is pulled through the slot in a substantially transverse direction to the flow of the resin melt through the first channel.

After the fiber bundle is pulled through the slot of the impregnation pin and wetted with the resin melt, the wetted fiber bundle is preferably woven through a series of wet-out rods to mechanically facilitate impregnation of resin. The impregnated fiber bundle is pulled through a consolidation unit, where the fiber bundle is shaped and excess molten polymer is removed. The consolidation unit typically includes a die which is substantially the shape of the desired cross-section of the pultruded part. In some embodiments, a series of wipe-off plates may precede the die. Each wipe-off plate has an opening approximately of the shape of the part that is to be formed. The dimensions of the openings in each successive wipe-off plate suitably become successively smaller further downstream of the impregnation unit, until the desired dimensions of the section that is to be formed is reached. Temperatures during this step are high enough that the polymer remains molten.

The shaped composite is then pulled through a cooling die, which solidifies the melt and provides a smooth surface. The cooling die has an opening that matches the cross-sectional dimensions of the article to be formed. The completed article is preferably pulled by a caterpillar-type haul off machine.

The resulting composite consists of longitudinally oriented reinforcing fibers bound together by a matrix of the thermoplastic resin. By “longitudinally oriented”, it is meant that the reinforcing fibers extend essentially continuously throughout the entire length of the composite and are aligned in the direction of pultrusion. The fiber content of the pultruded article is typically from about 40 to about 70 volume percent. The fiber content may be, for example, about 45 to about 65 volume percent or from about 45 to about 60 volume percent.

The composite advantageously exhibits a flexural modulus of at least 700 MPa, such as from 750-2000 MPa or from 800 to 1500 MPa.

The reinforcing fiber can be any strong, stiff fiber that is capable of being processed into a composite through a pultrusion process. The fiber must have a softening temperature in excess of the temperatures it encounters in the pultrusion process. Glass, other ceramics, carbon, metal or high melting polymeric (such as aramid) fibers are suitable. Mixtures of different types of fibers can be used. Moreover, fibers of different types can be layered or interwoven within the composite in order to optimize certain desired properties. For example, glass fibers can be used in the interior regions of the composite and more expensive fibers such as carbon fibers used in the exterior regions. This permits one to obtain the benefits of the high stiffness of the carbon fibers while reducing the overall fiber cost. Glass is a preferred fiber due to its low cost, high strength and good stiffness. Carbon fibers are especially preferred because of their excellent strength and stiffness. Suitable fibers are well known and commercially available. Fibers having individual diameters in the range of about 10 to 50 microns, preferably about 10-25 microns, are particularly suitable.

The fibers are typically using in the form of rovings that consist of hundreds to thousands of individual fibers. Rovings having from 100 to 30,000 or more individual fibers, such as 5000-2000 individual fibers, can be used. Similarly, multiple rovings can be used to form larger cross-sectional composites.

The thermoplastic polymer is a material having several characteristics. It is polar. Polymers containing repeating heterogroups having oxygen, nitrogen and/or sulfur atoms are considered to be polar for purpose of this invention. The heterogroups can be pendant or form part of the polymer backbone. Specific examples of such heterogroups include ether, ketone, ester, urethane, carbonate, amide, sulfide, sulfone, nitrile, and like groups.

In addition, the thermoplastic polymer does not contain certain types of functional groups which tend to decrease the thermal stability of the polymer.

The functional groups that tend to promote polymer degradation include non-aromatic carbon-carbon sites of unsaturation (i.e., carbon-carbon double or triple bonds), reactive ring structures, and functional groups containing active hydrogen atoms (such as hydroxyl, primary or secondary amino groups, carboxylic acid and thiol groups). “Reactive” ring structures are of two main types. The first type includes non-aromatic ring structures that contain only carbon atoms in the ring, such as cycloalkyl and cycloalkenyl groups. The second type includes ring structures which contain one or more heteroatoms in the ring and can engage in ring-opening reactions with other like ring structures or other groups or materials present in the polymer. Examples of such groups include cyclic ether, thioether or ester groups and non-aromatic cyclic groups containing a nitrogen atom in the ring.

Thermoplastic polymers meeting these criteria include, for example, styrene-acrylonitrile (SAN) copolymers, polyesters such as polyethylene terephthalate, polybutylene terephthalate and other polyesters formed from an aromatic dicarboxylic acid (or corresponding anhydride) and an alkylene glycol or glycol ether or a ring-opening polymerization of a cyclic lactone; polymers of hydroxyacids such as glycolic acid or lactic acid; ethylene vinyl acetate copolymers, ethylene vinyl alcohol copolymers, polyphenylene sulfide, polycarbonates, aromatic polyamide resins, polyetheretherketone (PEEK), polyacrylates and polymethacrylates such as polymethylmethacrylate, polyethersulfones, and blends thereof. A polymer of particular interest is a styrene-acrylonitrile copolymer. This copolymer is relatively inexpensive yet exhibits good adhesion to reinforcing fibers, can be processed at high line speeds, and forms composites having excellent physical properties, notably high flexural modulus.

In addition, the thermoplastic polymer is substantially devoid of materials that act to degrade the polymer at the pultrusion processing temperatures. By “substantially devoid”, it is meant that these materials are present, in the aggregate, in amounts less than 100 ppm by weight, preferably less than 10 ppm by weight, and more preferably less than 1 ppm by weight, based on the weight of the thermoplastic polymer. These materials include materials that for example (1) react with the polymer under the conditions of the pultrusion process, (2) catalyze a degradation reaction of the polymer or (3) react with another component present in the polymer to form an agent that degrades the polymer or reacts with the polymer. As discussed before, such materials include commonly used additives such as antioxidants; colorants such as pigments or dyes; impact modifiers; rubbers; biocides such as antimicrobials or fungicides; flame retardants; UV stabilizers; antistatic agents; surfactants, demolding agents; and flow promoters. In addition, thermal degradation of the polymer can be promoted by the presence of impurities in the polymer, such as residual catalysts (and degradation products thereof), transition metal ions, unreacted monomers and/or oligomers, and the like.

Accordingly, the thermoplastic polymer is preferably used “neat”, i.e., not combined with additives of any type that degrade or react (with themselves or other components in the resin) at the pultrusion processing temperature or below. In particular, the thermoplastic polymer is one that is not blended with any antioxidant; colorant such as pigments or dyes; impact modifier, rubber, biocide, flame retardant, UV stabilizer, antistatic agent, surfactant, demolding agent, metal, transition metal-containing compound, and flow promoter. In particular, it is preferred that the thermoplastic polymer is not blended with another polymer other than another polar thermoplastic polymer as described above.

It is also preferred that the thermoplastic polymer has been treated to remove residual polymerization catalysts or degradation products thereof, as may be used in producing the polymer. These materials are preferably removed to levels below 10 ppm, especially below 1 ppm and even more especially below 0.1 ppm. It is especially preferred to use a thermoplastic polymer that has been devolatilized to remove volatile impurities, such as unreacted monomers, solvents and/or water that may be used in the polymerization process, and/or volatile catalysts resides or catalyst degradation products.

In addition to having the foregoing characteristics, the thermoplastic polymer preferably exhibits (as a neat resin) a Shore A hardness of at least 95, a glass transition temperature (T_{g}) of not less than 50° C., or both. It is also preferably one that is not depolymerizable and repolymerizable at the pultrusion processing temperatures. In the case of a thermoplastic polyurethane, an otherwise depolymerizable and repolymerizable material can be used in this invention, if it is substantially devoid of polymerization catalysts and catalyst residues that would catalyze the depolymerization/repolymerization reactions.

The selection of the thermoplastic polymer as described tends to be less susceptible to thermal degradation. This reduced susceptibility often enables the polymer to be processed at significantly higher temperatures than otherwise could be used, without encountering significant degradation of the polymer. The higher process temperatures decrease the viscosity of the polymer melt, which improves wet-out of the reinforcing fibers. The improved wet-out leads directly to several advantages, such as the ability to operate at higher line speeds, and the ability to form larger cross-section composites, while forming a composite having excellent physical properties. Operating at higher line speeds tends to consume the polymer at a faster rate, which reduces the amount of time the polymer must be held at or near the processing temperature. The reduced time at processing temperature help to further minimize the amount of thermal degradation that the polymer undergoes.

Operating temperatures (i.e., the temperature of the polymer melt) in this invention therefore can be any temperature at which the thermoplastic polymer is molten, but is preferably at least 20° C. higher than the melting temperature of the polymer, and is suitably from about 30° C. to about 100° C. or from about 30 to about 80° C. higher than the melting temperature of the polymer. The melting temperature, for purposes of this invention, is considered to be the lowest temperature at which the polymer forms a fluid having a viscosity of no greater than 100 Ns/m². For example, a styrene-acrylonitrile polymer having a recommending processing temperature of 200-230° C. for injection molding applications and 161-246° C. for extrusion applications is suitably processed in this invention at a temperature of 270° C. or above, especially about 270° C. to 290° C. These temperatures are 24-44° C. above the highest recommended extrusion processing temperature, and at least 40° C. above the highest recommended injection molding processing temperature.

Thus, the invention allows for the production of good quality protruded articles at line speeds in excess of 1.5 meters/minute, such as from 1.5 to 15 meters/minute, or from 1.75-10 meters/minute, or from 1.8 to about 3.5 meters/minute. A particular advantage of the invention is that these line speeds are readily obtained even when producing pultruded articles having cross-sectional areas of at least 10 mm², such as from about 20 to about 510 mm², or about 35 to about 300 mm², or about 60 to about 300 mm², or about 70 to about 200 mm², or pultruded articles having thicknesses (minimum cross-sectional dimensions) of at least 4 mm, particularly from 6-20 mm, at fiber contents as described before.

The pultruded articles may be formed in a variety of cross-sectional shapes such as, for example, rods, “C” sections, “I” sections, tubes and other longitudinally hollow shapes, tapes, and other shapes having a longitudinally uniform cross-section.

Because the binder is a thermoplastic, the pultruded article can be post-formed by heating it to a temperature at which the polymer softens and shaping it. Bends, twists and other geometrical changes can be made to the pultruded part in this manner. The pultruded part can be welded or joined to other parts in analogous manner. For example, thicker cross-section parts can be prepared by thermally welding multiple layers of the pultruded article. Thermoforming, hot stamping and welding methods are suitable for performing the post-forming step. The pultruded articles can be cut to any desired length.

The following examples are provided for illustrative purposes only and are not intended to limit the scope of this invention. All parts and percentages are by weight unless otherwise indicated.

### EXAMPLE 1

A pultrusion is made on an apparatus substantially as described in U.S. Pat. No. 5,891,560. The resin is a styrene-acrylonitrile copolymer available commercially as Tyril® 125 resin from The Dow Chemical Company. This resin is prepared with no added colorants, modifiers or other additives. Its maximum recommended use temperature is about 230° C. for injection molding applications and about 246° C. for extrusion applications. The reinforcing fibers are Owens Corning 366 glass fiber rovings with a yield of 207 yards/pound (416 meters/kg). 70 rovings are used to provide a calculated 68% by weight glass in the pultruded product.

Circular rods having a 0.5 inch (12.7 mm) diameter (cross-sectional area of ˜127 mm²) are pultruded by pulling the fibers through the resin bath at a line speed of about 7 feet/minute (2.1 meters/minute). The resin bath is held at a temperature of 280° C., and the glass is not pre-heated. The pultrusion appears transparent during the process, which indicates that complete wet-out of the fibers has occurred.

The pultruded rod has a flexural modulus of 5.1 million psi (35 GPa) and a flexural strength of 148,000 psi (1 GPa).

### EXAMPLE 2

6 mm×10 mm strips are pultruded using the same glass fibers and resin as used in Example 1. 36 rovings are used to provide a calculated 73% by weight glass in the pultruded part. The resin bath temperature in this case is 270° C. and the glass is preheated to 150° C. before entering the die. Line speed is 10 feet/minute (3.05 meters/minute). The pultruded strip appears transparent, indicating that complete wet-out has occurred. The strips have a flexural modulus of 5.9 million psi (40 GPa) and a flexural strength of 154,000 psi (1.06 GPa).

What is claimed is:

1. A method for preparing a fiber-reinforced thermoplastic composite article comprising the steps of
a) drawing a fiber bundle continuously through a molten polar thermoplastic polymer, so as to impregnate said fiber bundle with said polar thermoplastic polymer;
b) forming the impregnated fiber bundle into a shaped article having longitudinally oriented fibers; and then
c) cooling the shaped article to a temperature at which the polar thermoplastic polymer solidifies,
wherein said polar thermoplastic polymer is substantially devoid of non-aromatic carbon-carbon unsaturation, reactive ring structures, and materials that act to degrade the polymer at the pultrusion processing temperature.

2. The method of claim 1, wherein the composite article has a cross-sectional area of at least 10 mm².

3. The method of claim 2, wherein the composite article has a minimum thickness of at least 4 mm.

4. The method of claim 3, wherein the composite article has a cross-sectional area of from 35 to about 300 mm².

5. The method of claim 4, which is operated at a line speed of at least 1.5 meters/minute.

6. The method of claim 5, wherein the fiber bundle is not preheated or is preheated to a temperature below the temperature of the molten polar thermoplastic polymer.

7. The method of claim 6, wherein the fiber bundle is preheated to a temperature of 200° C. or less.

8. The method of claim 7, wherein the polar thermoplastic polymer is not depolymerizable and repolymerizable.

9. The method of claim 8, wherein the polar thermoplastic polymer is a styrene-acrylonitrile copolymer, a polyester formed from an aromatic dicarboxylic acid or corresponding anhydride and an alkylene glycol or glycol ether; a polyester formed in a ring-opening polymerization of a cyclic lactone; a polymer of a hydroxyacid; an ethylene vinyl acetate copolymer, an ethylene vinyl alcohol copolymer, a polyphenylene sulfide polymer, a polycarbonate, an aromatic polyamide resin, a polyetheretherketone resin, a polyacrylate, a polymethacrylate or a polyethersulfone,

10. The method of claim 8, wherein the polar thermoplastic polymer is a styrene-acrylonitrile copolymer.

11. A method for preparing a fiber-reinforced thermoplastic composite article comprising the steps of
a) drawing a fiber bundle continuously through a molten styrene-acrylonitrile polymer, so as to impregnate said fiber bundle with said styrene-acrylonitrile polymer;
b) forming the impregnated fiber bundle into a shaped article having longitudinally oriented fibers; and then
c) cooling the shaped article to a temperature at which the styrene-acrylonitrile polymer solidifies,
wherein said styrene-acrylonitrile polymer is substantially devoid of materials that act to degrade the polymer at the pultrusion processing temperature.

12. The method of claim 11, wherein the composite article has a cross-sectional area of at least 10 mm².

13. The method of claim 12, wherein the composite article has a minimum thickness of at least 4 mm.

14. The method of claim 13, wherein the composite article has a cross-sectional area of from 35 to about 300 mm².

15. The method of claim 14, which is operated at a line speed of at least 1.5 meters/minute.

16. The method of claim 15, wherein the fiber bundle is not preheated or is preheated to a temperature below the temperature of the molten styrene-acrylonitrile polymer.

17. The method of claim 16, wherein the fiber bundle is preheated to a temperature of 200° C. or less.
